(19) United States
(12) Patent Application Publication
(10) Pub. No.: US 2024/0144570 A1
(43) Pub. Date: May 2, 2024

(54) METHOD FOR GENERATING DRIVABLE 3D CHARACTER, ELECTRONIC DEVICE AND STORAGE MEDIUM

(71) Applicant: BEIJING BAIDU NETCOM SCIENCE TECHNOLOGY CO., LTD., bEIJING (CN)

(72) Inventors: Qu CHEN, Beijing (CN); Xiaoqing YE, Beijing (CN); Xiao TAN, Beijing (CN); Hao SUN, Beijing (CN)

(73) Assignee: BEIJING BAIDU NETCOM SCIENCE TECHNOLOGY CO., LTD., Beijing (CN)

(21) Appl. No.: 17/794,081

(22) PCT Filed: Jan. 29, 2022
(86) PCT No.: PCT/CN2022/075024

§ 371 Date: Dec. 8, 2022

(30) Foreign Application Priority Data
Jun. 1, 2021 (CN) 202110609318.X

(51) Int. Cl. G06T 13/40; G06T 3/40

(52) U.S. Cl. CPC G06T 13/40; G06T 3/40

(57) ABSTRACT

A method and apparatus for generating a drivable 3D character, an electronic device and a storage medium are disclosed, which relate to the field of artificial intelligence, such as computer vision, deep learning, or the like, and may be applied to 3D vision and other scenarios. The method may include: acquiring a 3D human body mesh model corresponding to a to-be-processed 2D image; performing a skeleton embedding operation on the 3D human body mesh model; and performing a skin binding operation on the 3D human body mesh model after the skeleton embedding operation to obtain a drivable 3D human body mesh model.

This application is a U.S. national phase of International Application No. PCT/CN2022/075024, filed on Jan. 29, 2022, which claims priority to Chinese Patent Application No. 202110609318.X, filed on Jun. 1, 2021, entitled “Method and Apparatus for Generating Drivable 3D Character, Electronic Device and Storage Medium”, which are hereby incorporated by reference in their entireties.

### TECHNICAL FIELD

The present disclosure relates to the field of artificial intelligence technologies, particularly to the fields of computer vision and deep learning, and more particularly to a method for generating a drivable 3D character, an electronic device, and a storage medium.

### BACKGROUND

Currently, a drivable 3-dimension (3D) character may be generated based on a single 2-dimension (2D) image; that is, 2D-image-based 3D animation may be implemented.

In order to obtain the drivable 3D character, the following implementation is usually adopted: based on an end-to-end training method, for any 2D image, a drivable 3D human body mesh model is directly generated using a pre-trained network model; that is, the drivable 3D human body mesh model may be generated through a pre-trained semantic space and semantic deformation field and a surface implicit function, or the like. However, the model training method is complicated, and requires a large quantity of training resources, or the like.

### SUMMARY

The present disclosure provides a method for generating a drivable 3D character, an electronic device and a storage medium.

A method for generating a drivable 3D character, includes:
acquiring a 3D human body mesh model corresponding to a to-be-processed 2D image;
performing a skeleton embedding operation on the 3D human body mesh model; and
performing a skin binding operation on the 3D human body mesh model after the skeleton embedding operation to obtain a drivable 3D human body mesh model.

An electronic device includes:
at least one processor; and
a memory connected with the at least one processor communicatively;
where the memory stores instructions executable by the at least one processor to enable the at least one processor to perform the method as mentioned above.

There is provided a non-transitory computer readable storage medium with computer instructions stored thereon, where the computer instructions are used for causing a computer to perform the method as mentioned above.

It should be understood that the statements in this section are not intended to identify key or critical features of the embodiments of the present disclosure, nor limit the scope of the present disclosure. Other features of the present disclosure will become apparent from the following description.

### BRIEF DESCRIPTION OF THE DRAWINGS

The drawings are used for better understanding the present solution and do not constitute a limitation of the present disclosure. In the drawings,

FIG. 1 is a flow chart of a method for generating a drivable 3D character according to a first embodiment of the present disclosure;

FIG. 2 is a flow chart of a method for generating a drivable 3D character according to a second embodiment of the present disclosure;

FIG. 3 is a schematic diagram of a 3D human body animation according to the present disclosure;

FIG. 4 is a schematic structural diagram of an apparatus 400 for generating a drivable 3D character according to an embodiment of the present disclosure; and

FIG. 5 shows a schematic block diagram of an exemplary electronic device 500 which may be configured to implement the embodiment of the present disclosure.

### DETAILED DESCRIPTION OF EMBODIMENTS

The following part will illustrate exemplary embodiments of the present disclosure with reference to the drawings, including various details of the embodiments of the present disclosure for a better understanding. The embodiments should be regarded only as exemplary ones. Therefore, those skilled in the art should appreciate that various changes or modifications can be made with respect to the embodiments described herein without departing from the scope and spirit of the present disclosure. Similarly, for clarity and conciseness, the descriptions of the known functions and structures are omitted in the descriptions below.

In addition, it should be understood that the term “and/or” only describes an association relationship between associated objects, and indicates that three relationships may exist. For example, A and/or B may indicate three cases: only A exists; both A and B exist; and only B exists. In addition, in this specification, the symbol “I” generally indicates that associated objects have a relationship of “or”.

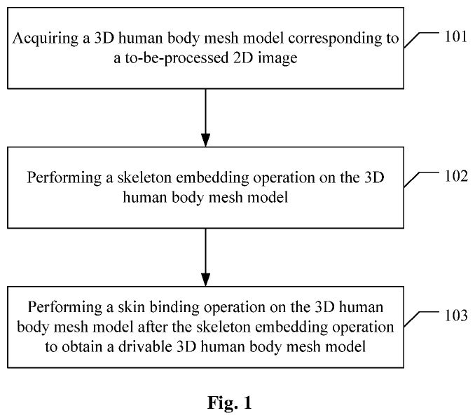

FIG. 1 is a flow chart of a method for generating a drivable 3D character according to a first embodiment of the present disclosure. As shown in FIG. 1, the method includes the following implementation steps:
Step 101: acquiring a 3D human body mesh model corresponding to a to-be-processed 2D image.
Step 102: performing a skeleton embedding operation on the 3D human body mesh model.
Step 103: performing a skin binding operation on the 3D human body mesh model after the skeleton embedding operation to obtain a drivable 3D human body mesh model.

In the solution according to the above method embodiment, the 3D human body mesh model corresponding to the to-be-processed 2D image may be acquired, and then, the skeleton embedding operation and the skin binding operation may be sequentially performed on the acquired 3D human body mesh model, so as to obtain the drivable 3D human body mesh model, instead of directly using a pre-trained network model to generate a drivable 3D human body mesh model in an existing method, thereby reducing consumed resources, or the like.

A method for acquiring the 3D human body mesh model corresponding to the to-be-processed 2D image is not limited. For example, an algorithm, such as a pixel-aligned implicit function (PIFu), a multi-level pixel-aligned implicit function for high-resolution 3D human digitization (PIFuHD), or the like, may be used to obtain the 3D human body mesh model corresponding to the to-be-processed 2D image, such as a 3D human body mesh model including about 200,000 vertexes and 400,000 facets.

The obtained 3D human body mesh model may be directly subjected to subsequent processing, for example, the skeleton embedding operation, or the like. In some embodiments, the obtained 3D human body mesh model may be down-sampled, and then, the down-sampled 3D human body mesh model may be subjected to the skeleton embedding operation, or the like.

Through the down-sampling operation, the 3D human body mesh model with fewer vertexes and facets may be obtained, thereby reducing the time required for subsequent processing operations and improving a processing efficiency, or the like.

A specific value of the down-sampling operation may be determined according to actual requirements, such as actual resource requirements. In addition, a method of performing the down-sampling operation is not limited. For example, the obtained 3D human body mesh model may be down-sampled using an edge collapse algorithm, a quadric error simplification algorithm, an isotropic remeshing algorithm, or the like.

Then, the skeleton embedding operation and the skin binding operation may be sequentially performed on the down-sampled 3D human body mesh model.

The 3D human body mesh model may be subjected to the skeleton embedding operation using a pre-constructed skeleton tree with N vertexes, herein N is a positive integer greater than one, and a specific value may be determined according to actual requirements.

The skeleton tree is essentially multiple sets of xyz coordinates, and a method of defining a skeleton tree with N vertexes is a prior art. In addition, a method of performing the skeleton embedding operation on the 3D human body mesh model using the skeleton tree is not limited; for example, the skeleton embedding operation may be realized using the pre-trained network model; that is, the pre-constructed skeleton tree with N vertexes and the 3D human body mesh model may be used as input to acquire the 3D human body mesh model output by the network model after the skeleton embedding.

By means of the constructed skeleton tree, the 3D human body mesh model after the skeleton embedding operation may be accurately and efficiently obtained with the above method, thus laying a good foundation for subsequent processing operations.

The skin binding operation may be further performed on the 3D human body mesh model after the skeleton embedding operation; that is, one weight relative to a skeleton location may be given to each of the N vertexes, thereby obtaining the drivable 3D human body mesh model.

If weight assignment is accurate, a skin may not be seriously torn and deformed when a skeleton is moved later, and looks more natural.

A method of performing the skin binding operation on the 3D human body mesh model is also not limited; for example, the skin binding operation may be implemented using the pre-trained network model.

After the series of processing operations, the required drivable 3D human body mesh model may be obtained. In some embodiments, based on the obtained drivable 3D human body mesh model, a 3D human body animation may be further generated.

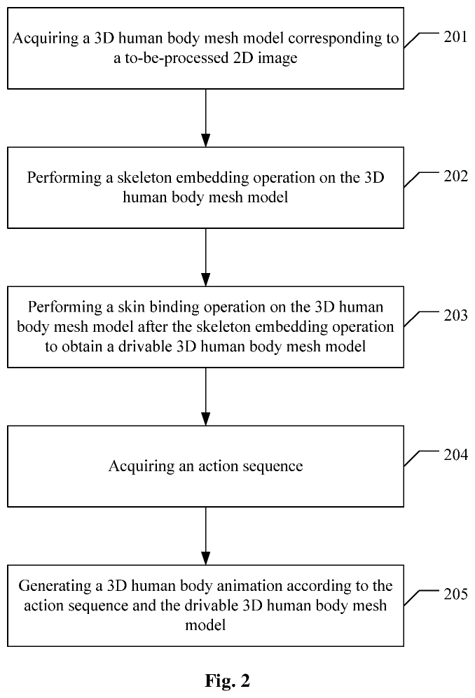

Correspondingly, FIG. 2 is a flow chart of a method for generating a drivable 3D character according to a second embodiment of the present disclosure. As shown in FIG. 2, the method includes the following implementation steps:
Step 201: acquiring a 3D human body mesh model corresponding to a to-be-processed 2D image.

For example, the 3D human body mesh model corresponding to the to-be-processed 2D image may be generated using a PIFu algorithm, a PIFuHD algorithm, or the like.
Step 202: performing a skeleton embedding operation on the 3D human body mesh model.

The 3D human body mesh model obtained in step 201 may be directly subjected to subsequent processing, for example, the skeleton embedding operation.

Alternatively, the 3D human body mesh model obtained in step 201 may be down-sampled first, and then, the down-sampled 3D human body mesh model may be subjected to the skeleton embedding operation.

The 3D human body mesh model may be subjected to the skeleton embedding operation using a pre-constructed skeleton tree with N vertexes, herein N is a positive integer greater than one.
Step 203: performing a skin binding operation on the 3D human body mesh model after the skeleton embedding operation to obtain a drivable 3D human body mesh model.

After the skeleton embedding operation and the skin binding operation are completed sequentially, the drivable 3D human body mesh model may be obtained. Based on the obtained drivable 3D human body mesh model, a 3D human body animation may be further generated.
Step 204: acquiring an action sequence.

In some embodiments, the action sequence may be a skinned multi-person linear model (SMPL) action sequence.

A method of generating the SMPL action sequence is a prior art.
Step 205: generating the 3D human body animation according to the action sequence and the drivable 3D human body mesh model.

Specifically, the SMPL action sequence may be migrated to obtain an action sequence with N key points, the N key points being N vertexes in the skeleton tree; and then, the drivable 3D human body mesh model may be driven using the action sequence with the N key points, thereby obtaining the required 3D human body animation.

Usually, a standardized SMPL action sequence corresponds to 24 key points, and a value of N is not 24 and is, for example, 17; then, the SMPL action sequence is required to be migrated to the skeleton tree with the N vertexes (key points), so as to obtain the action sequence with the N key points.

It should be noted that, if the value of N is 24, the above-mentioned migration is not required.

A method for obtaining the action sequence with the N key points is not limited; for example, various existing action migration methods or a pre-trained network model may be used, input is the SMPL action sequence, and output is the action sequence with the N key points.

When the network model is trained, a loss function may be defined as an Euclidean distance of corresponding key points in a 3D space, and the corresponding key points refer to matched key points; for example, 17 (the value of N) of the 24 key points corresponding to the SMPL action sequence are matched with the N key points in the skeleton tree, the residual 7 key points are then unmatched key points, and weights of location differences of the unmatched key points may be reduced or directly set to 0.

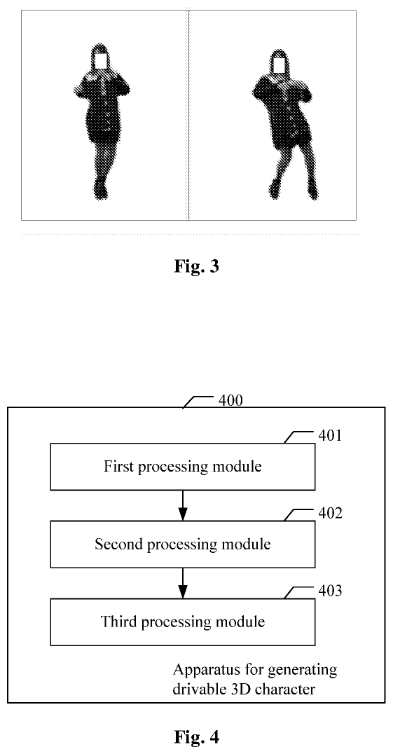

After the action sequence with the N key points is obtained, the drivable 3D human body mesh model obtained previously may be driven using the action sequence with the N key points, so as to obtain the 3D human body animation. As shown in FIG. 3, FIG. 3 is a schematic diagram of the 3D human body animation according to the present disclosure.

It can be seen from the above description that the drivable 3D human body mesh model according to the present disclosure is compatible with the standardized SMPL action sequence, and a corresponding 3D human body animation may be accurately and efficiently generated according to the drivable 3D human body mesh model and the SMPL action sequence.

In summary, a pipeline is constructed in the method according to the present disclosure, and the drivable 3D human body mesh model and the 3D human body animation may be generated for any input 2D image and SMPL action sequence; although some network models may be used, these network models are relatively simple, and compared with a method of directly using a trained network model to generate a drivable 3D human body mesh model in the prior art, the method according to the present disclosure reduces consumed resources, is applicable to any dressed human body and any action sequence, and has wide applicability, or the like.

It should be noted that for simplicity of description, all the above-mentioned embodiments of the method are described as combinations of a series of acts, but those skilled in the art should understand that the present disclosure is not limited by the described order of acts, as some steps may be performed in other orders or simultaneously according to the present disclosure. Further, those skilled in the art should also understand that the embodiments described in this specification are exemplary embodiments and that acts and modules referred to are not necessary for the present disclosure. In addition, for parts that are not described in detail in a certain embodiment, reference may be made to the related descriptions of other embodiments.

The above is a description of an embodiment of the method, and an embodiment of an apparatus according to the present disclosure will be further described below.

FIG. 4 is a schematic structural diagram of an apparatus 400 for generating a drivable 3D character according to an embodiment of the present disclosure. As shown in FIG. 4, the apparatus includes:
a first processing module 401 configured to acquire a 3D human body mesh model corresponding to a to-be-processed 2D image;
a second processing module 402 configured to perform a skeleton embedding operation on the acquired 3D human body mesh model; and
a third processing module 403 configured to perform a skin binding operation on the 3D human body mesh model after the skeleton embedding operation to obtain a drivable 3D human body mesh model.

There is no limitation on a way in which the first processing module 401 acquires the 3D human body mesh model corresponding to the to-be-processed 2D image. For example, the 3D human body mesh model corresponding to the to-be-processed 2D image may be obtained using a PIFu algorithm, a PIFuHD algorithm, or the like.

The second processing module 402 may directly perform subsequent processing, for example, the skeleton embedding operation, or the like, on the obtained 3D human body mesh model. In some embodiments, the second processing module 402 may first down-sample the obtained 3D human body mesh model, and then perform the skeleton embedding operation, or the like, on the down-sampled 3D human body mesh model.

A method of performing the down-sampling operation is also not limited. For example, the obtained 3D human body mesh model may be down-sampled using an edge collapse algorithm, a quadric error simplification algorithm, an isotropic remeshing algorithm, or the like.

The second processing module 402 may perform the skeleton embedding operation on the 3D human body mesh model using a pre-constructed skeleton tree with N vertexes, herein N is a positive integer greater than one.

A method of performing the skeleton embedding operation on the 3D human body mesh model using the skeleton tree is not limited; for example, the skeleton embedding operation may be realized using the pre-trained network model; that is, the pre-constructed skeleton tree with N vertexes and the 3D human body mesh model may be used as input to acquire the 3D human body mesh model output by the network model which has been subjected to the skeleton embedding operation.

The third processing module 403 may further perform the skin binding operation on the 3D human body mesh model after the skeleton embedding operation; that is, one weight relative to a skeleton location may be given to each of the N vertexes, thereby obtaining the drivable 3D human body mesh model. A method of performing the skin binding operation on the 3D human body mesh model is also not limited; for example, the skin binding operation may be implemented using the pre-trained network model.

After the series of processing operations, the required drivable 3D human body mesh model may be obtained. In some embodiments, based on the obtained drivable 3D human body mesh model, a 3D human body animation may be further generated.

Correspondingly, the third processing module 403 may be further configured to acquire an action sequence, and generate the 3D human body animation according to the obtained action sequence and the drivable 3D human body mesh model.

The action sequence may be a SMPL action sequence.

The third processing module 403 may first migrate the SMPL action sequence to obtain an action sequence with N key points, the N key points being N vertexes in the skeleton tree; and then, the third processing module 403 may drive the drivable 3D human body mesh model using the action sequence with the N key points, thereby obtaining the required 3D human body animation.

Usually, a standardized SMPL action sequence corresponds to 24 key points, and a value of N is not 24 and is, for example, 17; then, the SMPL action sequence is required to be migrated to the skeleton tree with the N vertexes (key points), so as to obtain the action sequence with the N key points.

After the action sequence with the N key points is obtained, the drivable 3D human body mesh model obtained previously may be driven using the action sequence with the N key points, so as to obtain the finally required 3D human body animation.

For the specific work flow of the embodiment of the apparatus shown in FIG. 4, reference is made to the related description in the foregoing embodiment of the method, and details are not repeated.

In summary, with the solution of the apparatus according to the embodiment of the present disclosure, the drivable 3D human body mesh model and the 3D human body animation may be generated for any input 2D image and SMPL action sequence; although some network models may be used, these network models are relatively simple, and compared with a method of directly using a trained network model to generate a drivable 3D human body mesh model in the prior art, the apparatus reduces consumed resources, is applicable to any dressed human body and any action sequence, and has wide applicability, or the like.

The solution of the present disclosure may be applied to the field of artificial intelligence, and particularly relates to the fields of computer vision, deep learning, or the like.

Artificial intelligence is a subject of researching how to cause a computer to simulate certain thought processes and intelligent behaviors (for example, learning, inferring, thinking, planning, or the like) of a human, and includes both hardware-level technologies and software-level technologies. Generally, the hardware technologies of the artificial intelligence include technologies, such as a sensor, a dedicated artificial intelligence chip, cloud computing, distributed storage, big data processing, or the like; the software technologies of the artificial intelligence mainly include a computer vision technology, a voice recognition technology, a natural language processing technology, a machine learning/deep learning technology, a big data processing technology, a knowledge graph technology, or the like.

According to the embodiment of the present disclosure, there are also provided an electronic device, a readable storage medium and a computer program product.

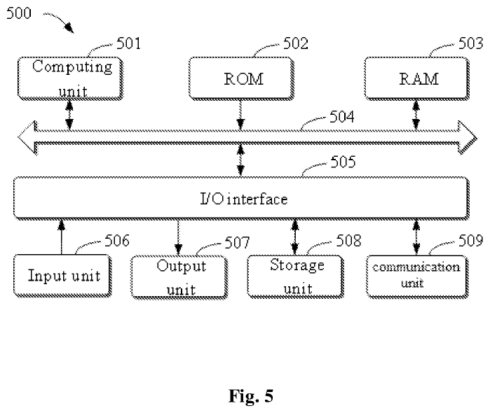

FIG. 5 shows a schematic block diagram of an exemplary electronic device 500 which may be configured to implement the embodiment of the present disclosure. The electronic device is intended to represent various forms of digital computers, such as laptop computers, desktop computers, workstations, servers, blade servers, mainframe computers, and other appropriate computers. The electronic device may also represent various forms of mobile devices, such as personal digital assistants, cellular telephones, smart phones, wearable devices, and other similar computing devices. The components shown herein, their connections and relationships, and their functions, are meant to be exemplary only, and are not meant to limit implementation of the present disclosure described and/or claimed herein.

As shown in FIG. 5, the device 500 includes a computing unit 501 which may perform various appropriate actions and processing operations according to a computer program stored in a read only memory (ROM) 502 or a computer program loaded from a storage unit 508 into a random access memory (RAM) 503. Various programs and data necessary for the operation of the device 500 may be also stored in the RAM 503. The computing unit 501, the ROM 502, and the RAM 503 are connected with one other through a bus 504. An input/output (I/O) interface 505 is also connected to the bus 504.

The plural components in the device 500 are connected to the I/O interface 505, and include: an input unit 506, such as a keyboard, a mouse, or the like; an output unit 507, such as various types of displays, speakers, or the like; the storage unit 508, such as a magnetic disk, an optical disk, or the like; and a communication unit 509, such as a network card, a modem, a wireless communication transceiver, or the like. The communication unit 509 allows the device 500 to exchange information/data with other devices through a computer network, such as the Internet, and/or various telecommunication networks.

The computing unit 501 may be a variety of general and/or special purpose processing components with processing and computing capabilities. Some examples of the computing unit 501 include, but are not limited to, a central processing unit (CPU), a graphic processing unit (GPU), various dedicated artificial intelligence (AI) computing chips, various computing units running machine learning model algorithms, a digital signal processor (DSP), and any suitable processor, controller, microcontroller, or the like. The computing unit 501 performs the methods and processing operations described above, such as the method according to the present disclosure. For example, in some embodiments, the method according to the present disclosure may be implemented as a computer software program tangibly contained in a machine readable medium, such as the storage unit 508. In some embodiments, part or all of the computer program may be loaded and/or installed into the device 500 via the ROM 502 and/or the communication unit 509. When the computer program is loaded into the RAM 503 and executed by the computing unit 501, one or more steps of the method according to the present disclosure may be performed. Alternatively, in other embodiments, the computing unit 501 may be configured to perform the method according to the present disclosure by any other suitable means (for example, by means of firmware).

Various implementations of the systems and technologies described herein above may be implemented in digital electronic circuitry, integrated circuitry, field programmable gate arrays (FPGA), application specific integrated circuits (ASIC), application specific standard products (ASSP), systems on chips (SOC), complex programmable logic devices (CPLD), computer hardware, firmware, software, and/or combinations thereof. The systems and technologies may be implemented in one or more computer programs which are executable and/or interpretable on a programmable system including at least one programmable processor, and the programmable processor may be special or general, and may receive data and instructions from, and transmit data and instructions to, a storage system, at least one input device, and at least one output device.

Program codes for implementing the method according to the present disclosure may be written in any combination of one or more programming languages. These program codes may be provided to a processor or a controller of a general purpose computer, a special purpose computer, or other programmable data processing devices, such that the program code, when executed by the processor or the controller, causes functions/operations specified in the flowchart and/or the block diagram to be implemented. The program code may be executed entirely on a machine, partly on a machine, partly on a machine as a stand-alone software package and partly on a remote machine, or entirely on a remote machine or a server.

In the context of the present disclosure, the machine readable medium may be a tangible medium which may contain or store a program for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination of the foregoing.

To provide interaction with a user, the systems and technologies described here may be implemented on a computer having: a display device (for example, a cathode ray tube (CRT) or liquid crystal display (LCD) monitor) for displaying information to a user; and a keyboard and a pointing device (for example, a mouse or a trackball) by which a user may provide input for the computer. Other kinds of devices may also be used to provide interaction with a user; for example, feedback provided for a user may be any form of sensory feedback (for example, visual feedback, auditory feedback, or tactile feedback); and input from a user may be received in any form (including acoustic, speech or tactile input).

The systems and technologies described here may be implemented in a computing system (for example, as a data server) which includes a back-end component, or a computing system (for example, an application server) which includes a middleware component, or a computing system (for example, a user computer having a graphical user interface or a web browser through which a user may interact with an implementation of the systems and technologies described here) which includes a front-end component, or a computing system which includes any combination of such back-end, middleware, or front-end components. The components of the system may be interconnected through any form or medium of digital data communication (for example, a communication network). Examples of the communication network include: a local area network (LAN), a wide area network (WAN) and the Internet.

A computer system may include a client and a server. Generally, the client and the server are remote from each other and interact through the communication network. The relationship between the client and the server is generated by virtue of computer programs which run on respective computers and have a client-server relationship to each other. The server may be a cloud server, also called a cloud computing server or a cloud host, and is a host product in a cloud computing service system, so as to overcome the defects of high management difficulty and weak service expansibility in conventional physical host and virtual private server (VPS) service. The server may also be a server of a distributed system, or a server incorporating a blockchain. The cloud computing technology is a technical system in which an elastically extensible shared physical or virtual resource pool is accessed through a network, resources may include servers, operating systems, networks, software, applications, storage devices, or the like, and the resources may be deployed and managed in a self-service mode according to needs; the cloud computing technology may provide an efficient and powerful data processing capacity for technical applications and model training of artificial intelligence, blockchains, or the like.

It should be understood that various forms of the flows shown above may be used and reordered, and steps may be added or deleted. For example, the steps described in the present disclosure may be executed in parallel, sequentially, or in different orders, which is not limited herein as long as the desired results of the technical solution disclosed in the present disclosure may be achieved.

The above-mentioned implementations are not intended to limit the scope of the present disclosure. It should be understood by those skilled in the art that various modifications, combinations, sub-combinations and substitutions may be made, depending on design requirements and other factors. Any modification, equivalent substitution and improvement made within the spirit and principle of the present disclosure all should be included in the extent of protection of the present disclosure.

1. A method for generating a drivable 3D character, comprising:
acquiring a 3D human body mesh model corresponding to a to-be-processed 2D image;
performing a skeleton embedding operation on the 3D human body mesh model; and
performing a skin binding operation on the 3D human body mesh model after the skeleton embedding operation to obtain a drivable 3D human body mesh model.

2. The method according to claim 1, further comprising:
down-sampling the 3D human body mesh model; and
performing the skeleton embedding operation on the down-sampled 3D human body mesh model.

3. The method according to claim 1, wherein the performing the skeleton embedding operation on the 3D human body mesh model comprises:
performing the skeleton embedding operation on the 3D human body mesh model using a pre-constructed skeleton tree with N vertexes, N being a positive integer greater than one.

4. The method according to claim 3, further comprising:
acquiring an action sequence; and
generating a 3D human body animation according to the action sequence and the drivable 3D human body mesh model.

5. The method according to claim 4, wherein the action sequence comprises a skinned multi-person linear model (SMPL) action sequence.

6. The method according to claim 5, wherein the generating the 3D human body animation according to the action sequence and the drivable 3D human body mesh model comprises:
migrating the SMPL action sequence to obtain an action sequence with N key points, the N key points being N vertexes in the skeleton tree; and
driving the drivable 3D human body mesh model using the action sequence with the N key points, so as to obtain the 3D human body animation.

7-12. (canceled)

13. An electronic device, comprising:
at least one processor; and
a memory connected with the at least one processor communicatively;
wherein the memory stores instructions executable by the at least one processor to enable the at least one processor to perform a method for generating a drivable 3D character, which comprises:
acquiring a 3D human body mesh model corresponding to a to-be-processed 2D image;
performing a skeleton embedding operation on the 3D human body mesh model; and
performing a skin binding operation on the 3D human body mesh model after the skeleton embedding operation to obtain a drivable 3D human body mesh model.

14. A non-transitory computer readable storage medium storing computer instructions for causing a computer to perform a method for generating a drivable 3D character, which comprises:
acquiring a 3D human body mesh model corresponding to a to-be-processed 2D image;
performing a skeleton embedding operation on the 3D human body mesh model; and
performing a skin binding operation on the 3D human body mesh model after the skeleton embedding operation to obtain a drivable 3D human body mesh model.

15. (canceled)

16. The method according to claim 2, wherein the performing the skeleton embedding operation on the 3D human body mesh model comprises:
performing the skeleton embedding operation on the 3D human body mesh model using a pre-constructed skeleton tree with N vertexes, N being a positive integer greater than one.

17. The electronic device according to claim 13, wherein the method further comprises:
down-sampling the 3D human body mesh model; and
performing the skeleton embedding operation on the down-sampled 3D human body mesh model.

18. The electronic device according to claim 17, wherein the performing the skeleton embedding operation on the 3D human body mesh model comprises:
performing the skeleton embedding operation on the 3D human body mesh model using a pre-constructed skeleton tree with N vertexes, N being a positive integer greater than one.

19. The electronic device according to claim 13, wherein the performing the skeleton embedding operation on the 3D human body mesh model comprises:
performing the skeleton embedding operation on the 3D human body mesh model using a pre-constructed skeleton tree with N vertexes, N being a positive integer greater than one.

20. The electronic device according to claim 19, wherein the method further comprises:
acquiring an action sequence; and
generating a 3D human body animation according to the action sequence and the drivable 3D human body mesh model.

21. The electronic device according to claim 20, wherein the action sequence comprises a skinned multi-person linear model (SMPL) action sequence.

22. The electronic device according to claim 21, wherein the generating the 3D human body animation according to the action sequence and the drivable 3D human body mesh model comprises:
migrating the SMPL action sequence to obtain an action sequence with N key points, the N key points being N vertexes in the skeleton tree; and
driving the drivable 3D human body mesh model using the action sequence with the N key points, so as to obtain the 3D human body animation.

23. The non-transitory computer readable storage medium according to claim 14, wherein the method further comprises:
down-sampling the 3D human body mesh model; and
performing the skeleton embedding operation on the down-sampled 3D human body mesh model.

24. The non-transitory computer readable storage medium according to claim 14, wherein the performing the skeleton embedding operation on the 3D human body mesh model comprises:
performing the skeleton embedding operation on the 3D human body mesh model using a pre-constructed skeleton tree with N vertexes, N being a positive integer greater than one.

25. The non-transitory computer readable storage medium according to claim 24, wherein the method further comprises:
acquiring an action sequence; and
generating a 3D human body animation according to the action sequence and the drivable 3D human body mesh model.

26. The non-transitory computer readable storage medium according to claim 25, wherein the action sequence comprises a skinned multi-person linear model (SMPL) action sequence.

27. The non-transitory computer readable storage medium according to claim 26, wherein the generating the 3D human body animation according to the action sequence and the drivable 3D human body mesh model comprises:
migrating the SMPL action sequence to obtain an action sequence with N key points, the N key points being N vertexes in the skeleton tree; and
driving the drivable 3D human body mesh model using the action sequence with the N key points, so as to obtain the 3D human body animation.
